(19) United States
(12) Patent Application Publication
(10) Pub. No.: US 2012/0021791 A1
(43) Pub. Date: Jan. 26, 2012

(54) METHOD FOR HANDOVER DECISION USING VIRTUAL SCHEDULER AND HANDOVER CONTROL DEVICE THEREOF

(75) Inventors: Nak Woon SUNG, Daejeon (KR); Soo Hwan Lee, Daejeon (KR); Yung Yi, Daejeon (KR); Sook Jin Lee, Daejeon (KR); Song Chong, Seoul (KR); Kyuho Son, Los Angeles, CA (US)

(73) Assignee: ELECTRONICS AND TELECOMMUNICATIONS RESEARCH INSTITUTE, Daejeon (KR)

(21) Appl. No.: 13/095,369

(22) Filed: Apr. 27, 2011

(30) Foreign Application Priority Data
Jul. 26, 2010 (KR) 10-2010-0072059

(51) Int. Cl. H04W 36/30; H04W 72/04

(52) U.S. Cl. 455/509

(57) ABSTRACT

Each base station performs virtual scheduling that does not take cell association into account for each slot and actual scheduling that takes cell association into account to calculate difference in average transmission rates for each user terminal and stores them in a table. The difference in the average transmission rates for each user terminal is compared with a difference in average transmission rates for each user terminal received from a neighboring base station to determine a handoff decision for each user terminal.

### CROSS-REFERENCE TO RELATED APPLICATION

This application claims priority to and the benefit of Korean patent application No. 10-2010-0072059 filed in the Korean Intellectual Property Office on Jul. 26, 2010, the entire contents of which are incorporated herein by reference.

### BACKGROUND OF THE INVENTION

(a) Field of the Invention

The present invention relates to a method for handover decision using a virtual scheduler and a handover control device thereof, and more particularly, to a method and device for making a handover decision in a mobile communication system in which a plurality of base stations and a plurality of users coexist.

(b) Description of the Related Art

The currently most popular handover is an SIR (signal-to-interference ratio balancing) method for handover to a base station with the highest signal-to-interference ratio. In accordance with this method, a user measures a channel environment of each base station through a pilot channel to perform handover to a base station having the best channel environment for a predetermined time.

However, a handover to a base station merely having a good channel environment may cause a serious overload in an environment where user distribution is asymmetric.

FIG. 1 is a configuration view of a conventional cellular system.

Referring to FIG. 1, when a handover decision is made by the SIR method, because most users are associated with base station A, an overload of base station A is caused. On the other hand, resources available for base station B are wasted because the number of associated users is relatively small, resulting in lowering the performance of the entire system.

In order to resolve these problems, much research has been performed. As representative methods, there are a load-aware handoff (LA-HO) method and a cell breathing method.

First, in the case of the LA-HO method, the criteria for user satisfaction is to achieve proportional fairness. This method is an algorithm for maximizing load balancing between cells and data throughput of a user by using the characteristic that each user is allocated with resources with equal opportunity regardless of the channel environment from a currently associated base station.

Specifically, each base station broadcasts an expected value of the total transmission rate that can be serviced by itself and the number of users currently associated with itself, that is, load information, to each user through a pilot channel every time interval. In view of proportional fairness, each user performs handover according to the following Equation 1 using the feature that each user is equally allocated with cell resources.

$$max \{ \frac{E [ {r}_{i , k} ( t ) ]}{E [ {K}_{i} ( t ) ]} , {\tilde{T}}_{i , k} ( t ) \} < {max}_{j ∈ {B}_{k}} \{ \frac{E [ {r}_{j , k} ( t ) ]}{E [ {K}_{j} ( t ) ] + 1} \} , \qquad ( Equation 1 )$$

According to Equation 1, the amount of resources usable when handover is performed (average transmission rate of base station/currently associated user+1, that is, the value of the right side) is compared with resources obtainable from the current base station when handover is not performed (average transmission rate of base station/currently associated user, that is, the value of the left side), and if the value of the right side is greater than the value of the left side, handover is performed.

Meanwhile, the cell breathing method is a method of achieving load balancing between cells by varying the level of fairness to be achieved from cell to cell and arbitrarily adjusting the cell radius.

Specifically, when min-max fairness is used, services are provided to users far from a base station having relatively low channel quality, thereby enlarging the overall cell area. When fairness with the objective of maximizing a sum is used, services are provided to users close to a base station having a relatively good channel quality, thereby narrowing the overall cell area. The cell breathing method is a method using this feature.

However, in the above-stated LA-HO method and cell breathing method, the problem that a system where the user satisfaction function is not a function of proportional fairness occurs, that is, proportional balancing is not used as a fairness measure, and cannot be taken into account.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method for handover decision using a virtual scheduler, which can maximize frequency efficiency irrespective of fairness measure by taking both channel quality and load balancing into account, and a handover control device thereof.

According to one aspect of the present invention, a method for handover decision is provided. The method, in which a base station makes a handover decision, includes: performing virtual scheduling where a maximum weight scheduling algorithm is applied to all user terminals communicable with the base station to obtain a first average transmission rate for each user terminal; performing actual scheduling where the maximum weight scheduling algorithm is applied to user terminals located within a cell coverage of the base station to obtain a second average transmission rate for each user terminal; calculating a first difference between the first average transmission rate for each user terminal obtained by the virtual scheduling and the second average transmission rate for each user terminal obtained by the actual scheduling; and making a handover decision for each user terminal by comparing the first difference in the first and second average transmission rates for each user terminal of the base station with a second difference, received from a neighboring base station, in a first and a second average transmission rates for each user terminal of a neighboring base station.

According to another aspect of the present invention, a handover control device is provided. The handover control device, which performs an operation of making a handover decision for a user in a base station, includes: a virtual scheduler for performing virtual scheduling where the base station applies a maximum weight scheduling algorithm to all user terminals communicable with the base station; an actual scheduler for performing actual scheduling where the maximum weight scheduling algorithm is applied to the user terminals located within the cell of the base station; a calculator for calculating a first difference between an average transmission rate for each user terminal obtained by the virtual scheduling and an average transmission rate for each user terminal obtained by the actual scheduling; a receiver for receiving a second difference for each user terminal from the neighboring base station, wherein the second difference represents a difference in an average transmission rate for each user terminal obtained by performing virtual scheduling and an average transmission rate for each user terminal obtained by performing actual scheduling in the neighboring base station; and a decision maker for making a handover decision for each user terminal by comparing the first difference with the second difference for each user terminal.

### BRIEF DESCRIPTION OF THE DRAWINGS

FIG. 1 is a configuration view of a conventional cellular system.

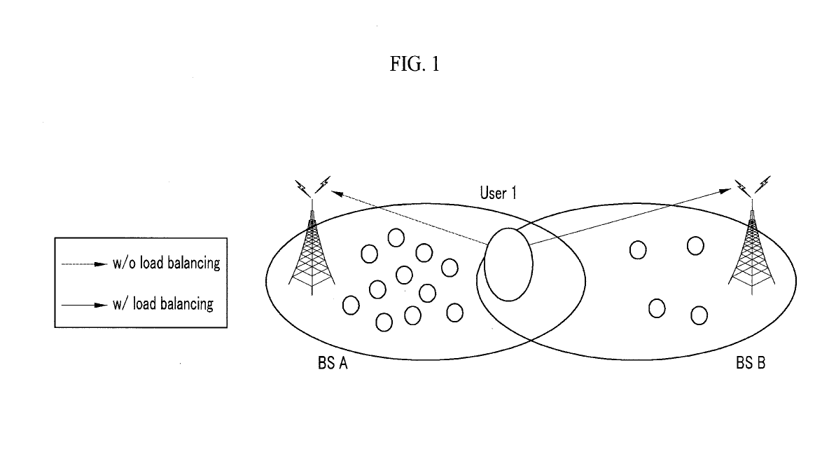

FIG. 2 is a block diagram showing the configuration of a handover control device according to an exemplary embodiment of the present invention.

FIG. 3 shows the configuration of tables containing differences in transmission rates for each user according to an exemplary embodiment of the present invention.

FIG. 4 is a flowchart of a method for handover decision according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. In the drawings, to clarify the present invention, parts that are not related to the description are omitted, and the same parts have the same drawing sequences through the specification.

Throughout the specification, unless explicitly described to the contrary, the word “comprise” and variations such as “comprises” or “comprising” will be understood to imply the inclusion of stated elements but not the exclusion of any other elements.

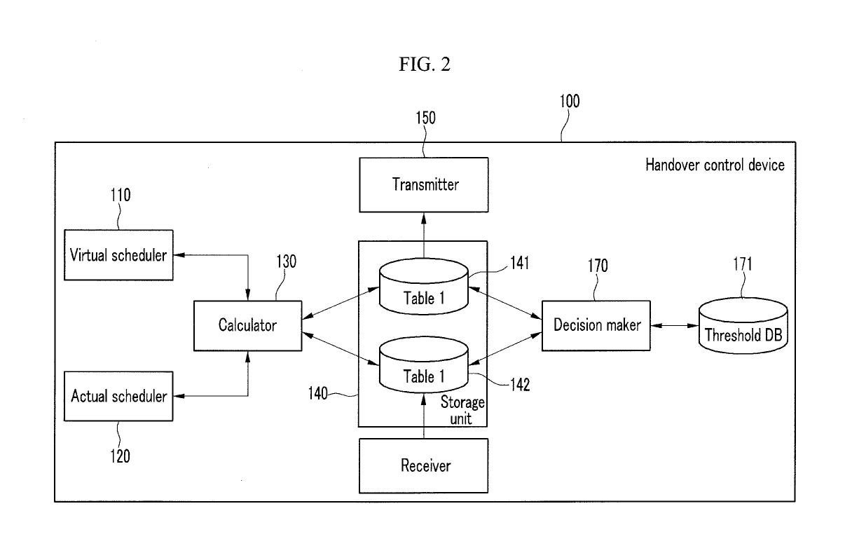

FIG. 2 is a block diagram showing the configuration of a handover control device according to an exemplary embodiment of the present invention.

The handover control device is provided for each base station (not shown) to perform an operation of making a handover decision.

Moreover, the handover control device is able to accurately detect the quality of a channel between a user associated with the cell of each base station and a user not associated with the base station but that is communicable with the base station through a pilot channel.

Referring to FIG. 2, the handover control device 100 includes a virtual scheduler 110, an actual scheduler 120, a calculator 130, a storage unit 140, a transmitter 150, a receiver 160, and a decision maker 170.

The virtual scheduler 110 performs virtual scheduling that does not take cell association into account for each slot. The virtual scheduler 110 performs a max-weight scheduling algorithm as shown in the following Equation 2.

$${K}_{n , i}^{*} ( t ) = arg {max}_{k ∈ K} \times {U}^{′} ( {\overline{R}}_{k} ( t - 1 ) ) \times {r}_{k , n , i , {p}^{*}} ( t ) \qquad ( Equation 2 )$$

In Equation 2, K denotes a set of all mobile communication users,
n={1, 2, 3, . . . , N} denotes a base station index,
i={1, 2, 3, . . . , I} denotes an index of an available channel,
R̅ₖ(t−1) denotes an average data transmission rate at which terminal k is serviced until the time slot preceding the current time slot t,
U′( R̅ₖ(t−1) denotes a differential value of user satisfaction measure given as a function of the average transmission rate R of user k, and
r_{k,n,i,p*}(t) denotes an instantaneous transmission rate user k can receive at time t from channel i of base station n.

At this point, when Equation 2 is applied to the set of all mobile communication users, one base station has to be aware of a differential value (weight value) of satisfaction of all the users of a cellular network and the transmission rate in this time slot in order to select a user to be serviced. As a result, overhead required for a base station and a terminal to send and receive messages is large. Even if it is assumed that all messages can be sent and received in real time, an exhaustive search for user k has to be performed over the entire network to perform Equation 2 at every slot. Thus, a high complexity of calculation is needed.

Therefore, the virtual scheduler 110 calculates Equation 2 by restricting a target to be taken into consideration for virtual scheduling to users within the reachable range of a pilot channel of a base station.

As such, restrictions on users are based on the idea that a difference in instantaneous transmission rate is more dominant than a difference in user satisfaction function in Equation 2, and instantaneous transmission rate depends on channel quality. Also, since the channel quality is not very good, users who are not aware of the channel quality may be intentionally excluded.

Moreover, as a user located at the periphery of a cell managed by a base station is in an environment overlapping with a cell managed by another base station, the base station with the best channel quality frequently changes from the user's perspective.

In this situation, if only the virtual scheduling of Equation 2 is applied, this leads to frequent handovers for each slot. It takes much longer time to perform handover in a real environment than doing scheduling for each slot in a base station.

Therefore, differences in the average transmission rates for each user obtained by virtual scheduling and actual scheduling, respectively, are used in making a handover decision. That is, it is intended to slowly follow optimum association of cells and scheduling based on the notion of virtual scheduling.

Here, the actual scheduler 120 performs actual scheduling considering this cell association to determine a user for each channel to be serviced for each slot. That is, actual scheduling as in the following Equation 3 is performed for each base station by taking users associated with the base station itself into consideration.

$${K}_{n , i}^{*} ( t ) = arg {max}_{k ∈ K ( n )} \times {U}^{′} ( {\overline{R}}_{k} ( t - 1 ) ) \times {r}_{k , n , i , {p}^{*}} ( t ) \qquad ( Equation 3 )$$

Equation 3 is similar to Equation 2 except that each base station searches for a service target only among user set “K(n)” belonging to the base station itself.

Here, the scheduling operations of the virtual scheduler 110 and the actual scheduler 120 are simultaneously performed.

The calculator 130 calculates, with respect to each slot, differences between the average transmission rate for each user obtained by the virtual scheduler 110 and the average transmission rate for each user delivered from the actual scheduler 120, and stores them in a table 1 141 of the storage unit 140.

The storage unit 140 stores the table 1 141 containing the differences in the average transmission rates for each user calculated by the calculator 130 and tables 2 142 containing differences in the average transmission rates for each user received from one or more neighboring base stations (not shown). At this point, the tables 2 142 are created and transmitted by handover control devices 100 respectively mounted in the one or more neighboring base stations.

As such, the table 1 141 and the tables 2 142 are implemented in the storage unit 140.

Thus, the transmitter 150 transmits the table 1 141 stored in the storage unit 140 to one or more neighboring base stations every prescribed time period.

The receiver 160 receives the respective tables 2 142 from the one or more neighboring base stations ever prescribed time period. At this point, the receiver 160 extracts the highest values of the differences in the average transmission rates for each user contained in the respective tables 2 142 and stores them in the table 1 141.

The decision maker 170 makes a handover decision by comparing the table 1 141 containing the differences in the average transmission rates for each user of the base station and the tables 2 142 containing the differences in the average transmission rates for each user of one or more neighboring base stations.

At this time, if the number of neighboring base stations is two or more, not all of the differences in the average transmission rates for each user of all the neighboring base stations, but only the highest values of the differences in the average transmission rates for each user of all the neighboring base stations, are selected. That is, the values of a field 141c of the table 1 141 are used.

The decision maker 170 makes a handover decision for a user satisfying the condition of the following Equation 4 among the differences in the average transmission rates for each user stored in a field 141b of the table 1 141.

$${K}^{*} ( n , t ) = {arg}_{k ∈ K} \{ A > B \times THRESHOLD \} \qquad ( Equation 4 )$$

Herein, A denotes a difference in the average transmission rates for each user between virtual scheduling and actual scheduling. That is, A represents a value stored in the field 141b of the table 1 141.

B denotes a difference in the average transmission rates for each user of neighboring base stations obtained by virtual scheduling and actual scheduling, respectively. That is, B represents a value stored in the field 141c of the table 1 141.

“THRESHOLD” represents a predefined threshold value, and the decision maker 170 is provided with a threshold DB 171 storing threshold values.

A threshold value determines how slowly optimum cell association is followed. That is, if the threshold value is too large, it takes too long a time to follow optimum cell association, thus failing to follow user mobility. On the other hand, if the threshold value is too small, the time and cost required for handover are not met, thus making it impossible to implement the threshold value. Therefore, the threshold value is set, for each base station, to a level at which the threshold value can be implemented, taking other environments, including computing performance, into account.

Moreover, the threshold value is a specific constant. In this way, the rate at which Equation 2 converges can be adjusted, so a faster handover time than the handover time required in the handover control device 100 can be achieved.

Further, satisfying Equation 4, i.e., larger differences in the average transmission rates than differences in the average transmission rates of neighboring base stations, means that a user can obtain a larger performance gain through handover.

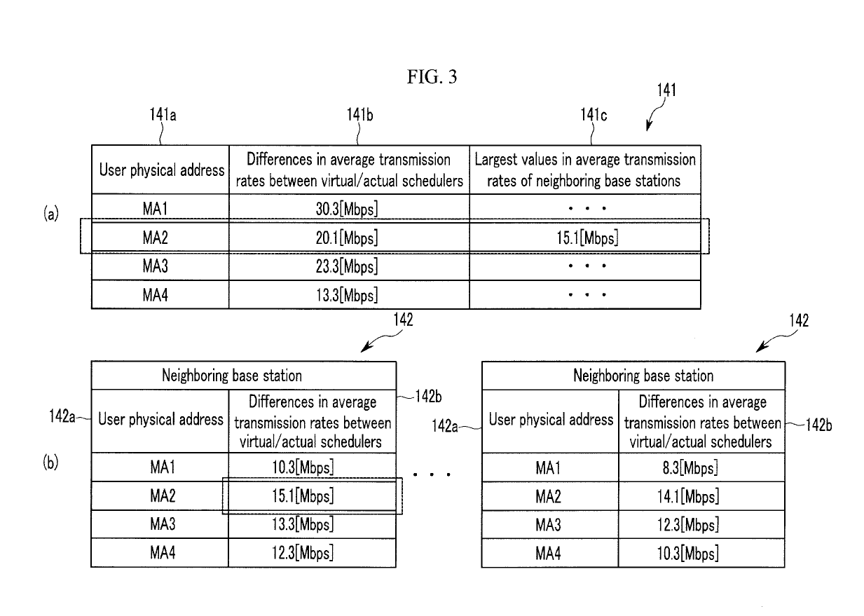

FIG. 3 shows the configuration of tables containing differences in transmission rate for each user according to an exemplary embodiment of the present invention. That is, FIG. 3 shows the configurations of the tables included in the storage unit 140.

Referring to FIG. 3, (a) shows the configuration of the table 1 141 that includes three fields. That is, the table 1 141 includes a user physical address field 141a and average transmission rate difference fields 141b and 141c. The average transmission rate difference fields 141b and 141c include a field 141b containing the differences in the average transmission rates between the virtual/actual schedulers and a field 141c containing the highest values of the differences in the average transmission rates of neighboring base stations.

(b) of FIG. 3 shows the configurations of the tables 2 142 containing the differences in the average transmission rates received from one or more neighboring base stations.

Each of the tables 2 142 includes, with respect to each base station, a user physical address field 142a and a field 141b containing the differences in the average transmission rates between the virtual/actual schedulers.

Here, the field 141c of the table 1 141 contains the highest values in the fields 142b of the tables 2 142 of the neighboring base stations.

For example, the highest value of the values contained in the fields 142b of the tables 2 142 of the respective base stations for user physical address MA2 is “15.1 [Mbps]” of a neighboring base station. Thus, this value is contained in the field 141c of the table 1 141 for user physical address MA2. Accordingly, if “20.1 [Mbps]” contained in the field 141b of the table 1 141 for user physical address MA2 is larger than a value obtained by multiplying “15.1 [Mbps]” contained in the field 141c of the table 1 141 by a predefined threshold value, the decision maker 170 makes a handover decision of user physical address MA2.

Now, the operation of the above handover control device 100 will be described, and the same reference numerals are used to describe the components associated with FIGS. 2 and 3.

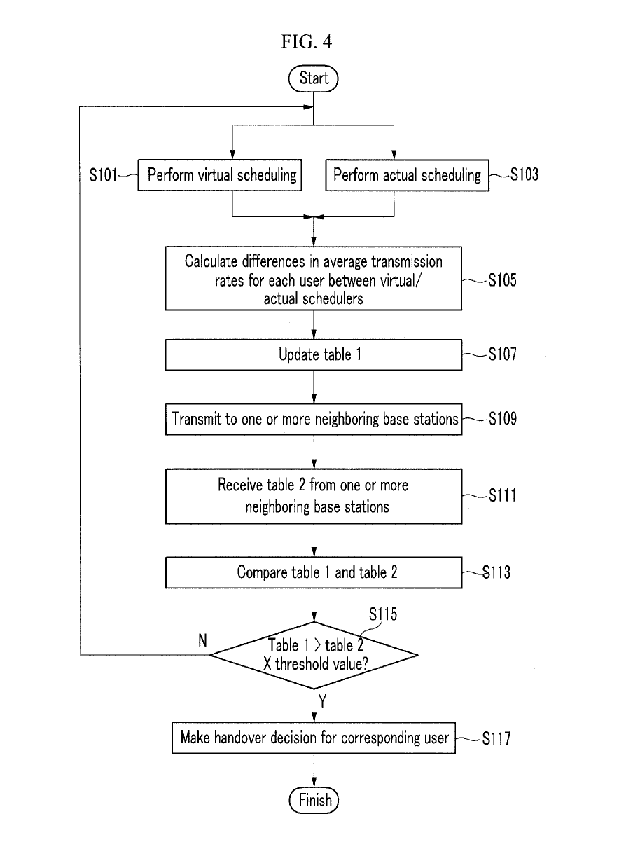

FIG. 4 is a flowchart of a method for handover decision according to an exemplary embodiment of the present invention.

Referring to FIG. 4, the virtual scheduler 110 performs virtual scheduling using Equation 2 for each slot to output the average transmission rate for each user (S101).

Also, the actual scheduler 120 performs actual scheduling using Equation 3 for each slot to output the average transmission rate for each user (S103).

Then, the calculator 130 calculates differences in the average transmission rates for each user delivered from the virtual scheduler 110 and the actual scheduler 120, respectively (S105). Here, the differences in the average transmission rates are calculated for each user as shown in FIG. 3.

The calculator 130 stores the differences in the average transmission rates for each user calculated in step S105 in the table 1 141 (S107).

At this point, if there are differences in the average transmission rates for each user stored for the previous slot in the table 1 141, the calculator 130 deletes the differences in the average transmission rates for each user for the previous slot and stores the differences in the average transmission rates for each user calculated for the current slot therein. Accordingly, differences in the average transmission rates for each user are updated every slot.

Then, the transmitter 150 transmits the table 1 141 of the storage unit 140 to one or more neighboring base stations (not shown) (S109). Here, the transmitter 150 performs step S109 every prescribed time period. Step 109 can be performed, for example, every several seconds.

The receiver 160 receives the tables 2 142 created by respective handover control devices of one or more neighboring base stations and stores them in the storage unit 140 (S111). Here, the receiver 160 deletes the tables 2 142 stored in the storage unit 140 in the previous time period, and stores the tables 2 142 received in the current period therein.

Then, the decision maker 170 compares, for each user, the values contained in the field 141b of the table 1 141 with the values contained in the fields 142 of the tables 2 142 (S113). Also, the decision maker 170 determines whether the values contained in the field 141b of the table 1 141 are larger than the values obtained by multiplying the values contained in the fields 142b of the tables 2 142 by a threshold value (S115).

In step S111, the receiver 160 determines whether the number of tables 2 142 is two or more. If so, the receiver 160 extracts the highest values of the differences in the average transmission rates for each user contained in the tables 2 142 and stores them in the field 141c of the table 1 141. Then, the decision maker 170 determines whether the values contained in the field 141b of the table 1 141 are larger than the values obtained by multiplying the values contained in the fields 142b of the tables 2 142 by a threshold value.

Thereafter, the decision maker 170 makes a handover decision for a user satisfying the condition of step S115 (S117). If the condition of S115 is not satisfied, the method is performed starting from step S101.

According to an exemplary embodiment of the present invention, by determining cell association for maximizing user satisfaction by always taking the fairness of all users into account irrespective of what type of fairness the criteria for user satisfaction adopts, optimum load balancing and optimum satisfaction of all users can be ultimately achieved in an environment where a plurality of cells are present.

Moreover, handover is performed at an actually implementable level by lowering the complexity of a mathematically derived optimum handoff method and message transmission rate.

The exemplary embodiments of the present invention are not only realized by the method and device, but are also realized by a program for realizing functions corresponding to the configurations of the exemplary embodiments of the present invention or a recording medium for recording the program.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for handover decision in a base station, the method comprising:
performing virtual scheduling where a maximum weight scheduling algorithm is applied to all user terminals communicable with the base station to obtain a first average transmission rate for each user terminal;
performing actual scheduling where the maximum weight scheduling algorithm is applied to user terminals located within a cell coverage of the base station to obtain a second average transmission rate for each user terminal;
calculating a first difference between the first average transmission rate for each user terminal obtained by the virtual scheduling and the second average transmission rate for each user terminal obtained by the actual scheduling; and
making a handover decision for each user terminal by comparing the first difference in the first and second average transmission rates for each user terminal of the base station with a second difference, received from a neighboring base station, in a first and a second average transmission rates for each user terminal of a neighboring base station

2. The method of claim 1, wherein, in the performing of the virtual scheduling, the application of the maximum weight scheduling algorithm is restricted to user terminals within a reachable range of a pilot channel of the base station.

3. The method of claim 1, wherein the making of a handover decision comprises:
performing a multiplication of the second difference in the average transmission rates for each user terminal of the neighboring base station by a predetermined threshold value;
comparing the result of the multiplication with the first difference in the average transmission rates for each user terminal of the base station; and
if the first difference in the average transmission rates for each user terminal of the base station is greater than the result of the multiplication, making a handover decision for the corresponding user terminal.

4. The method of claim 3, wherein the making of a decision for the corresponding user further comprises,
before the performing of the multiplication,
selecting a largest difference among at least two second differences in the average transmission rates provided from at least two neighboring base stations, and,
in the performing of the multiplication, the largest difference is multiplied by the threshold value.

5. The method of claim 4, further comprising, between the calculating and the handover decision for each user, mapping the first difference in the average transmission rates of the base station and the largest difference selected among the least two second differences provided from the at least two neighboring base stations with a physical address of each user terminal ans storing them in a table.

6. The method of claim 5, wherein, in the storing, if a first difference calculated for a previous slot exists in the table, the table is updated with a first difference calculated for a current slot.

7. The method of claim 5, further comprising,
between the calculating and the handover decision for each user:
transmitting the first difference in average transmission rates for each user terminal stored in the table calculated for each slot to at least one neighboring base station; and
receiving a second difference in average transmission rates for each user terminal of each neighboring base station from the at least one neighboring base station.

8. A handover control device, which performs an operation of making a handover decision for a user in a base station, comprising:
a virtual scheduler for performing virtual scheduling where the base station applies a maximum weight scheduling algorithm to all user terminals communicable with the base station;
an actual scheduler for performing actual scheduling where the maximum weight scheduling algorithm is applied to the user terminals located within the cell of the base station;
a calculator for calculating a first difference between an average transmission rate for each user terminal obtained by the virtual scheduling and an average transmission rate for each user terminal obtained by the actual scheduling;
a receiver for receiving a second difference for each user terminal from the neighboring base station, wherein the second difference represents a difference in an average transmission rate for each user terminal obtained by performing virtual scheduling and an average transmission rate for each user terminal obtained by performing actual scheduling in the neighboring base station; and
a decision maker for making a handover decision for each user terminal by comparing the first difference with the second difference for each user terminal.

9. The handover control device of claim 8, further comprising a transmitter for transmitting the first difference in the average transmission rates for each user terminal calculated for each slot by the calculator to at least one neighboring base station.

10. The handover control device of claim 9, wherein the virtual scheduler performs the virtual scheduling by restricting the application of the maximum weight scheduling algorithm to user terminals within the reachable range of a pilot channel of the base station.

11. The handover control device of claim 8, wherein, if the first difference in the average transmission rates for each user terminal is greater than a value obtained by multiplying the second difference for each user terminal from the neighboring base station by a predetermined threshold, the decision maker makes a handover decision for a corresponding user terminal.

12. The handover control device of claim 11, wherein the receiver receives at least two second differences for each user terminal from at least two neighboring base stations, and
the decision maker selects a largest difference among the second differences for each user terminal and performs the multiplication based on the largest difference.

13. The handover control device of claim 12, further comprising a storage unit for storing a table in which the first difference and the largest difference for each user terminal are mapped with a physical address of each use terminal.

14. The handover control device of claim 13, wherein, if a first difference for each user terminal calculated for a previous slot exists in the table stored in the storage unit, the table is updated with a first difference for each user terminal calculated for a current slot.
